(19) United States
(12) Patent Application Publication
(10) Pub. No.: US 2025/0164239 A1
(43) Pub. Date: May 22, 2025

(54) SYSTEMS AND METHODS FOR ANALYSING THE SURFACE QUALITY OF A SUBSTRATE WITH PARALLEL FACES

(71) Applicant: IMAGINE OPTIC, Orsay (FR)

(72) Inventors: Xavier Levecq, Gif-Sur-Yvette (FR); Nicolas Lefaudeux, Forges-Les-Bains (FR)

(73) Assignee: IMAGINE OPTIC, Orsay (FR)

(21) Appl. No.: 18/840,421

(22) PCT Filed: Feb. 16, 2023
(86) PCT No.: PCT/EP2023/053887

§ 371 Date: Aug. 21, 2024

(30) Foreign Application Priority Data
Feb. 21, 2022 (FR) FR2201527

(51) Int. Cl. G01B 11/30

(52) U.S. Cl. CPC G01B 11/303; G01B 2210/56

(57) ABSTRACT

A method for analyzing the surface quality of a substrate may include emitting a first light beam incident on a first face of said substrate, receiving a first reflected beam resulting from the reflection of the first beam by the first face and a second reflected beam resulting from a reflection by a second face of the substrate in order to generate at least a first measurement signal characteristic of a combination of the wavefronts of the first and second reflected beams, receiving a transmission beam resulting from transmission of the substrate by a second light beam in order to generate a second measurement signal, and calculating, from the first and second measurement signals, a first signal and a second signal representative of a deformation of the first face and the second face respectively.

### TECHNICAL FIELD OF THE INVENTION

The present description relates to systems and methods for analyzing the surface quality of a substrate with parallel faces, and, more particularly, concerns the analysis of the deformations of the surfaces of such a substrate.

### PRIOR ART

The topography of surfaces of materials with parallel faces, referred to simply as “substrates” in the present description, is relevant in many fields, these materials possibly including, for example, glass substrates for computer hard disks, silicon photomasks and wafers for the semiconductor industry, flat screens and glass displays for mobile devices, windows, X-ray telescope optics, optical filters, beam splitters, protective domes, and the like.

It is important to be able to study and quantify any deformations of the surfaces of such substrates, since these deformations may give rise to distortions in systems that use them. Contactless optical methods for analyzing the surface quality of a substrate are known. One difficulty encountered in most methods in the analysis of the surface quality of a face of the substrate is the contribution of reflection by the other face (the rear face), notably in the case of transparent substrates in the spectral band of the optical source used for measurement.

Various metrological methods for analyzing the surface quality of thin transparent materials which can overcome the effect of reflection on the rear face are described, for example, in the review article Metrology of thin transparent optics using Shack-Hartmann wavefront sensing, by Craig R. Forest et al. [Ref. 1].

Notably, it is known to apply a coating with a suitable index to the rear face in order to suppress reflection from the rear face, or to apply a highly reflective coating to the front face, but these methods require coating application and cleaning operations and may themselves give rise to surface deformations.

[Ref. 1] also describes methods of phase shifting interferometry, in which a white or low-coherence light source is used to avoid parasitic interference due to reflections on both faces of the substrate. These methods, using Michelson interferometers for example, are difficult to implement and are limited to substrates in which the deformations are much smaller than the thickness.

As explained in [Ref. 1], phase shifting interferometry methods using frequency-tunable laser sources may also be considered. For example, interference measurements may be made on three surfaces (a reference surface, the front face and the rear face of the substrate) sequentially, at two different wavelengths, after which new interference measurements are made, again at two wavelengths but with the substrate turned over, so that the rear face is facing the reference surface. The contributions of the interferences of the plane and parallel surfaces of the material, and notably the contribution due to the interference between the front face and the reference surface, can then be separated mathematically. However, this method requires the manipulation of the specimen, which has to be turned over to make the two sets of measurements, and this may be inconvenient in the case of fragile and easily deformable materials. More generally, there are known methods using frequency variation sources, in which a Fourier analysis of the spectrum of the interference signal can extract the profiles of the different faces. All these methods require numerous acquisitions, making them highly sensitive to the environment, and notably to vibration.

[Ref. 1] also describes methods for the spatial separation of the reflections from the front and rear faces, enabling the reflections from the rear face to be blocked with a shutter.

These include, for example, interferometric methods using oblique or spherical illumination (also known as “grazing incidence interferometry”). However, these methods are highly sensitive to the alignment of the components.

In addition to interferometry-based methods, [Ref. 1] introduces a method for analyzing the optical quality of a face of a thin transparent material using a Shack-Hartmann wavefront analyzer.

As shown in FIG. 1, taken from [Ref. 1], a Shack-Hartmann wavefront analyzer comprises an array of microlenses 20 and an array of elementary detectors 30. If a reference wavefront, for example a flat reference wavefront, is incident on the microlens array 20, each microlens (20i, 20j, . . . ) intercepts and focuses part of the wavefront without deflection, resulting in a regular arrangement of the barycenters of the focal spots on the array of elementary detectors 30. If, on the contrary, as shown in FIG. 1, a wavefront 10 is incident on a deformation relative to the flat reference wavefront, the microlenses (201, 20j, . . . ) intercept parts (10i, 10j, . . . ) of the wavefront which have non-zero slopes locally. This results in a displacement of the barycenter of the focal spots on the elementary detector array 30. On the basis of the measurement signal determined in this way, and in accordance with a two-dimensional matrix of the displacements, it is possible to determine a matrix of the local slopes of the wavefront and to deduce therefrom a matrix of the values of the wavefront measured at each microlens relative to the reference wavefront, by numerical integration of the values of the local slopes, for example. Since the local deformations of the face being analyzed are directly proportional to the local deformations of the wavefront, the deformations can thus be determined on the basis of the Shack-Hartmann measurement signal.

By comparison with the interferometric techniques described above, metrological methods using a Shack-Hartmann wavefront analyzer, or more generally a device implementing a wavefront analyzer that analyzes the wavefront directly, make it possible, notably, to use light sources that are temporally incoherent or have low temporal coherence, these sources usually being less expensive than lasers, and to operate in a less controlled environment; these solutions are also less costly.

However, as explained in [Ref. 1], reflection from the rear face may interfere with the measurement of the surface quality of the front face, notably when working with light sources comprising wavelengths at which the material is at least partially transparent Thus, it has been suggested that spectral filters should be installed for filtering all wavelengths in the transparent domain of the material, or that sources whose wavelength is not transmitted by the material of the substrate to be analyzed should be used. Published patent application WO 2004/068088 [Ref. 2] describes the use of two wavefront analyzers, in this case lateral shift interferometers (or “shearing interferometers”), for simultaneous reflection and transmission measurements on the substrate whose surface defects are to be measured. Like the Shack-Hartmann wavefront analyzer, such lateral shift interferometers can be used for direct measurement of the wavefront: they do not use interference with a reference beam, and are sensitive to the first derivative of the wavefront. The reflection measurement provides information on the topology of a face and the transmission measurement provides information on the variation of thickness of the substrate. The two measurements can be combined to obtain information on the topology of both faces of the substrate. This method works well, but its implementation is complicated, because the reflection measurement of one face of the substrate must not be interfered with by the reflection from the second face. For this purpose, it is proposed that a wavelength at which the substrate material is opaque, that is to say absorbent, should be used for this reflection measurement. This makes it necessary to choose a wavelength in the UV or in the far infrared, for example, which requires special sensors and optics, thus giving rise to constraints in terms of choice of materials and costs.

One object of the present description is to propose systems and methods for analyzing the surface quality of the two faces of a substrate with parallel faces, using wavefront analyzers which allow one or more light sources with low temporal coherence to be used, while not being subject to the constraints in terms of devices and methods described in [Ref. 2].

### SUMMARY OF THE INVENTION

In the present description, the term “comprise” has the same meaning as “include” or “contain”, and is inclusive or open and does not exclude other elements that are not described or represented.

Further, in the present description, the term “approximately” or “substantially” is synonymous with (means the same as) an upper or lower margin of 10%, for example 5%, of the respective value.

According to a first aspect, the present description relates to a method for analyzing the surface quality of a substrate with parallel faces, comprising:
emitting, by at least one first light source of emission means, at least one first light beam with low temporal coherence, said at least one first light beam being incident on said substrate, said substrate being at least partially transparent to at least one wavelength of said first incident light beam;
receiving, by at least one first wavefront analyzer of wavefront analysis means, at least one first reflected beam and a second reflected beam, said first reflected beam resulting from reflection of said at least one first light beam by a first face of the substrate and said second reflected beam resulting from a first transmission through the substrate of said first light beam and then a reflection by a second face of the substrate, followed by a second transmission through the substrate, in order to generate at least one first measurement signal characteristic of a combination of the wavefronts of said first and second reflected beams;
receiving, by said wavefront analysis means, at least one first transmitted beam resulting from at least one first transmission through the substrate of a second light beam emitted by said emission means, in order to generate a second measurement signal characteristic of the wavefront of said transmitted beam,
calculating, from said at least one first measurement signal and said second measurement signal, at least one first signal representative of a deformation of said first face of the substrate relative to a first reference surface and at least one second signal representative of a deformation of the second face of the substrate relative to a second reference surface.

In the present description, a “substrate with parallel faces” is taken to mean an optical element with a first face and a second face, the distance between the two faces, measured along an axis perpendicular to the faces, being substantially constant over the whole of the optical element, that is to say having a variation of thickness of less than +/−10%. A substrate with parallel faces may be flat, in which case an angle between said faces is less than approximately 5 minutes of arc. Other shapes of substrates with parallel faces may be considered in the present description, for example curved substrates such as protective domes.

In the present description, a light beam with low temporal coherence is a light beam having a low enough temporal coherence to be free of any interference effects between the reflected beams on the faces of the substrate, such interference effects possibly causing problems with measurement. For this purpose, it is advantageous in practice for the temporal coherence length of the first light beam to be less than approximately twice the optical thickness of the substrate with parallel faces to be analyzed, the optical thickness of the substrate being the thickness of the substrate multiplied by the mean refractive index of the material of which it is made. The temporal coherence of the first light beam is less than or equal to approximately 100 μm, or advantageously less than or equal to approximately 10 μm. Thus, for example, with a first light beam whose temporal coherence is less than or equal to approximately 10 μm, it is possible to analyze the surfaces of very thin substrates, that is to say those with a thickness of several tens of microns. It should be noted that the temporal coherence length of the first light beam sets a minimum thickness for the substrates to be analyzed, but does not impose any further limitation. With the same light source whose temporal coherence is less than or equal to approximately 10 μm, for example, substrates with thicknesses of several tens of centimeters can also be analyzed. According to one or more examples of embodiment, said at least one first light beam and said second light beam are spatially coherent.

If, for example, a Shack-Hartmann wavefront analyzer is used, the first and second light beams have sufficient spatial coherence for the resulting reflected or transmitted beams, incident on the microlens array, to generate focal spots whose size is smaller than the size of the microlenses generating them.

As a general rule, it is known that the accuracy of wavefront analyzers decreases when the spatial coherence of the source generating the light beams also decreases, that is to say when the angular size of the source increases. The spatial coherence of the light beams must therefore be sufficient to allow measurement by the analyzer with an accuracy compatible with the requirements of the application. For example, as explained above, for Shack-Hartmann sensors, it is known that the accuracy of the measurement is not greatly affected if the angular size of the light beam emission source extended into the space of the analyzer is less than the diffraction angle of a microlens.

According to one or more examples of embodiment, said at least one first light source for the emission of said at least one first light beam with low temporal coherence is a source chosen from among: an incandescent lamp, a light emitting diode (LED), a super-luminescent diode (SLED), which may be fiberized in a monomode fiber, and a laser diode used below its laser effect generation threshold, which may be fiberized in a monomode fiber.

In the present description, the substrate is said to be at least partially transparent to at least one wavelength of a beam passing through it when the transmission of said beam, at said wavelength, is at least equal to 10%, or advantageously at least equal to 30%.

In the present description, by contrast with the methods described in the prior art, such as the method described in [Ref. 2], it is thus ensured that the first light beam incident on the substrate to be analyzed is at least partially transmitted by the substrate, so that the combined wavefronts of the beams reflected by the first and second faces of the substrate can be analyzed by means of said at least one first wavefront analyzer of the wavefront analysis means.

In the present description, the term “wavefront” of a light beam is applied to a surface having the same phase as the electromagnetic wave forming said beam. Thus, if for example a flat surface of a substrate without defects is illuminated with a flat reference wave, the wavefront of the reflected beam is also flat. If the surface has local deformations relative to a flat reference surface, the wavefront of the reflected beam is deformed relative to the flat reference wavefront. In the present description, a wavefront analysis is thus a measurement of the deformations of said wavefront relative to a reference wavefront, for example, but not necessarily, a flat wavefront. For example, in the analysis of a curved substrate, the reference wavefront could be a spherical wavefront.

Thus, in the present description, the first measurement signal, the second measurement signal and the signals characteristic of the deformations of the first and second surfaces of the substrate are matrix signals, that is to say signals composed of two-dimensional matrices of values.

In the present description, “wavefront analyzer” signifies a device for directly measuring the wavefront of a beam to be analyzed, as opposed to interferometric techniques that use the interference of the beam to be analyzed with a reference beam. Such a device makes it possible, in general, to determine the local slopes of the wavefront (that is to say, the first derivatives of the wavefront), and are usually based on an analysis of the variation of the angle of travel of light rays, using a wavefront sensor comprising a set of one or more optical elements and a detector which is usually two-dimensional.

According to one or more examples of embodiment, said at least one first wavefront analyzer of the wavefront analysis means is chosen from among: a Hartmann and Shack Hartmann wavefront analyzer, as described in [Ref. 3] for example, a lateral shift interferometer, as described in [Ref. 4] for example, a moiré deflectometer, as described in [Ref. 5] for example, and a device based on the Schlieren method, as described in [Ref. 6] for example. According to one or more examples of embodiment, said at least one first light beam is incident on said substrate in a manner substantially perpendicular to said substrate. Although it is possible to envisage arrangements in which the first light beam is incident on the substrate with an inclination relative to the normal, a substantially normal incidence is preferred because it simplifies the optical assembly and makes it possible to avoid introducing any lateral shift between the first reflected beam and the second reflected beam, notably in the case of thick substrates.

According to one or more examples of embodiment, said second light beam is incident on said first face of the substrate and the method further comprises, for the generation of the second measurement signal.
positioning a reference mirror, arranged in a manner substantially perpendicular to said second light beam; and wherein
said first transmitted beam results from a first transmission through the substrate of said second light beam, a reflection by the reference mirror and a second transmission through the substrate of the beam reflected by the reference mirror; and
said first transmitted beam is received by said first wavefront analyzer of the wavefront analysis means.

The method thus described may be implemented with a single wavefront analyzer and a single light emission source, the first light beam and the second light beam possibly being emitted by the same light source.

The reference mirror may be flat, in the case where the aim is to analyze a flat substrate with parallel or curved faces, or spherical, for example, in the case where the aim is to analyze a substrate with non-zero curvature.

According to some examples of embodiment, the reference mirror may be arranged in a removable manner. In other examples of embodiment, it may be maskable, using a shutter for example, or may be orientable, by a motorized or non-motorized rotation system, so that the beam reflected by the mirror is not received by the wavefront analysis means. In both cases, this makes it possible to obtain the first measurement signal characteristic of a combination of the wavefronts of said first and second reflecting mirrors, in the case where the mirror is not present or is masked or rotated, and to obtain the second measurement signal characteristic of the wavefront of said transmitted beam when the reference mirror is present and not masked or rotated.

According to one or more examples of embodiment:
said second light beam is incident on said first face of the substrate;
said first transmitted beam results from a first transmission through the substrate of said second light beam; and
said first transmitted beam is received by a second wavefront analyzer of the wavefront analysis means, separate from the first wavefront analyzer.

The method thus described is implemented with wavefront analysis means comprising two separate wavefront analyzers, which may be identical or different. Since said first and second light beams can be emitted simultaneously by the same light source, the first measurement signal, characteristic of a combination of the wavefronts of said first and second reflected beams, and the second measurement signal, characteristic of the wavefront of said transmitted beam, can be obtained simultaneously without the manipulation of a reference mirror.

According to one or more examples of embodiment:
said second light beam is emitted by a second light source of the emission means, separate from the first source, and is incident on said second face of the substrate;
said first transmitted beam results from a first transmission through the substrate of said second light beam; and
said first transmitted beam is received by said first wavefront analyzer of the measurement analysis means.

The method thus described is implemented with emission means comprising two separate emission sources, the emission sources being either identical or different. It enables the first measurement signal, characteristic of a combination of the wavefronts of said first and second reflected beams, and the second measurement signal, characteristic of the wavefront of said transmitted beam, to be obtained without the manipulation of a reference mirror.

Thus, in the case of emission sources of different kinds, according to one or more examples of embodiment, said first light beam emitted by said first light source and said second light beam emitted by said second light source have a different wavelength and/or polarization. The method may then further comprise:
receiving, by a second wavefront analyzer of the wavefront analysis means, separate from the first wavefront analyzer, a second transmitted beam resulting from a first transmission through the substrate of said first light beam, in order to generate a third measurement signal characteristic of the wavefront of said second transmitted beam; and
comparing said second measurement signal characteristic of the wavefront of said first transmitted beam and said third measurement signal characteristic of the wavefront of said second transmitted beam, in order to generate a signal characteristic of the variations of the refractive index within the substrate.

According to a second aspect, the present description relates to systems for analyzing the surface quality of a substrate with parallel faces for the implementation of the analysis methods according to the first aspect.

Thus the system according to the second aspect comprises:
at least one first support configured to receive the substrate to be analyzed;
emission means comprising at least one first light source for emitting at least one first light beam with low temporal coherence, and having at least one wavelength to which said substrate is at least partially transparent, said emission means being configured so that, in operation, said at least one first light beam is incident on said substrate;
wavefront analysis means comprising at least one first wavefront analyzer and configured, in operation, for:
receiving, on an analysis surface of said first wavefront analyzer, at least one first reflected beam and a second reflected beam, said first reflected beam resulting from the reflection of said at least one first light beam by a first face of the substrate and said second reflected beam resulting from a first transmission through the substrate of said first light beam and then a reflection by a second face of the substrate, followed by a second transmission through the substrate, in order to generate a first measurement signal characteristic of a combination of the wavefronts of said first and second reflected beams;
receiving, by said wavefront analysis means, at least one first transmitted beam resulting from at least one first transmission through the substrate of a second light beam emitted by said emission means, in order to generate a second measurement signal characteristic of the wavefront of said transmitted beam;
a processing unit configured for calculating, from said first measurement signal and said second measurement signal, at least one first signal representative of a deformation of said first face of the substrate relative to a first reference surface and at least one second signal representative of a deformation of the second face of the substrate relative to a second reference surface.

According to one or more examples of embodiment, said emission means are configured so that, in operation, said at least one first beam is incident on said substrate in a manner substantially perpendicular to said substrate.

According to one or more examples of embodiment, said analysis surface of said first wavefront analyzer is optically conjugate with the substrate to be analyzed.

In one or more embodiments, the system further comprises:
a second support configured for receiving a reference mirror, the reference mirror being arranged, in operation, in a manner substantially perpendicular to said second light beam; and wherein, in operation:
said first transmitted beam results from a first transmission through the substrate of said second light beam, a reflection by the reference mirror and a second transmission through the substrate of the beam reflected by the reference mirror; and
said first and second reflected beams and said first transmitted beam are received by said first wavefront analyzer of the wavefront analysis means.

According to one or more examples of embodiment, the wavefront analysis means comprise a second wavefront analyzer, separate from the first wavefront analyzer, and: said emission means are configured so that, in operation, said second light beam is incident on said first face of the substrate, said first transmitted beam resulting from a first transmission through the substrate of said second light beam;
said wavefront analysis means are configured so that, in operation, said first transmitted beam is received by said second wavefront analyzer of the wavefront analysis means.

According to one or more examples of embodiment, said at least one first wavefront analyzer of the wavefront analysis means is chosen from among: a Hartmann and Shack-Hartmann wavefront analyzer, as described in [Ref. 3] for example, a lateral shift interferometer, as described in [Ref. 4] for example, a moiré deflectometer, as described in [Ref. 5] for example, and a device based on the Schlieren method, as described in [Ref. 6] for example.

### BRIEF DESCRIPTION OF THE FIGURES

Other advantages and characteristics of the invention will become clear in the light of the description, illustrated by the following figures:

FIG. 1, described above, a diagram illustrating the principle of a Shack-Hartmann analyzer according to the prior art.

FIG. 2A, a diagram illustrating a first step of an example of a method for analyzing the surface quality of a substrate according to the present description, using a first example of a system for analyzing the surface quality of a substrate according to the present description.

FIG. 2B, a diagram illustrating a second step of an example of a method for analyzing the surface quality of a substrate according to the present description, using the system for analyzing the surface quality of a substrate illustrated in FIG. 2A.

FIG. 3A, a diagram illustrating the measurement of a signal characteristic of a combination of the wavefronts of the first and second reflected beams with a Shack-Hartmann analyzer, in a step of a method for analyzing the surface quality of a substrate according to the present description.

FIG. 3B, a diagram illustrating in greater detail the measurement illustrated in FIG. 3A.

FIG. 4A, a diagram illustrating an example of deformation undergone by a flat wavefront reflected by a first face of a substrate when the first face has a surface defect relative to a flat reference surface.

FIG. 4B, a diagram illustrating an example of deformation undergone by a flat wavefront initially transmitted by the substrate illustrated in FIG. 4A, then reflected by the second face of a substrate, and then transmitted a second time by the substrate, when the second face has a surface defect.

FIG. 4C, a diagram illustrating an example of deformation undergone by a flat wavefront transmitted by the substrate illustrated in FIG. 4B, then reflected by a reference mirror and re-transmitted by the substrate.

FIG. 5A, a diagram illustrating a first step of an example of a method for analyzing the surface quality of a substrate according to the present description, using a second example of a system for analyzing the surface quality of a substrate according to the present description, adapted for analyzing a substrate with non-zero curvature.

FIG. 5B, a diagram illustrating a second step of an example of a method for analyzing the surface quality of a substrate according to the present description, using the system for analyzing the surface quality of a substrate illustrated in FIG. 5A.

FIG. 6, a diagram illustrating steps of an example of a method for analyzing the surface quality of a substrate according to the present description, using a third example of a system for analyzing the surface quality of a substrate according to the present description.

FIG. 7, a diagram illustrating steps of an example of a method for analyzing the surface quality of a substrate according to the present description, using a fourth example of a system for analyzing the surface quality of a substrate according to the present description.

FIG. 8, a diagram illustrating steps of an example of a method for analyzing the surface quality of a substrate according to the present description, using a fifth example of a system for analyzing the surface quality of a substrate according to the present description.

FIG. 9, experimental images representing matrices of deformations of the faces of a substrate, the images being obtained with a system as illustrated in FIGS. 2A and 2B.

FIG. 10A, a diagram illustrating a first step of an example of a method for analyzing the surface quality of a substrate according to the present description, using a sixth example of a system for analyzing the surface quality of a substrate according to the present description, adapted for an incidence of the first light beam on the substrate with an angle of inclination.

FIG. 10B, a diagram illustrating a second step of an example of a method for analyzing the surface quality of a substrate according to the present description, using the system for analyzing the surface quality of a substrate illustrated in FIG. 10A.

FIG. 10C, a diagram illustrating limits to the implementation of a method for analyzing the surface quality of a substrate, using the system for analyzing the surface quality of a substrate illustrated in FIG. 10A.

### DETAILED DESCRIPTION OF THE INVENTION

For greater clarity, the elements in the figures are not shown to scale.

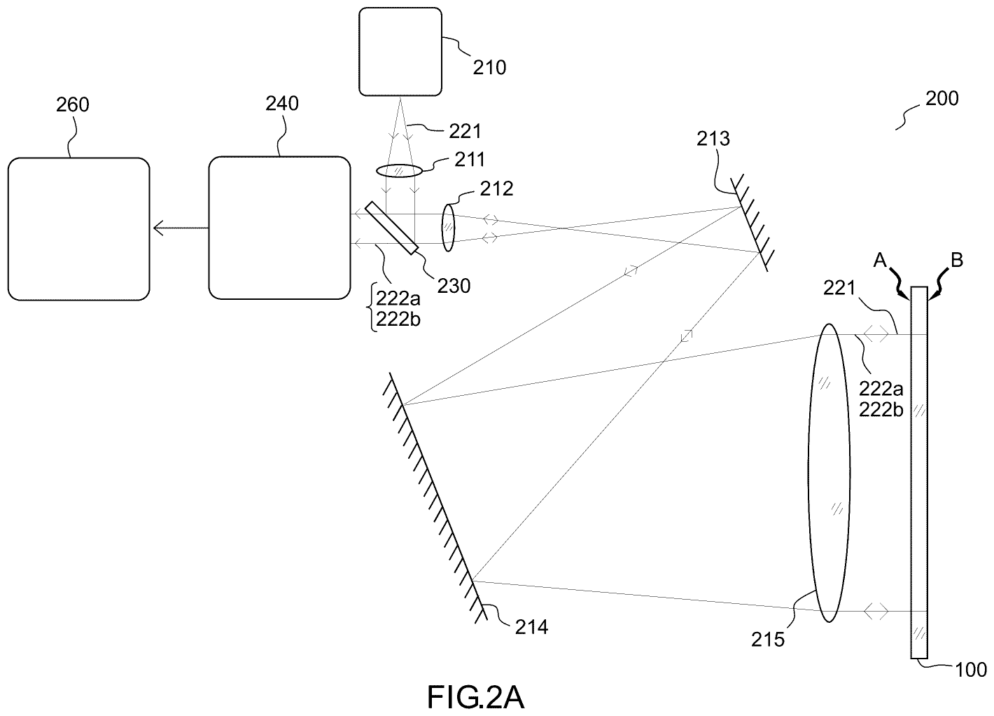

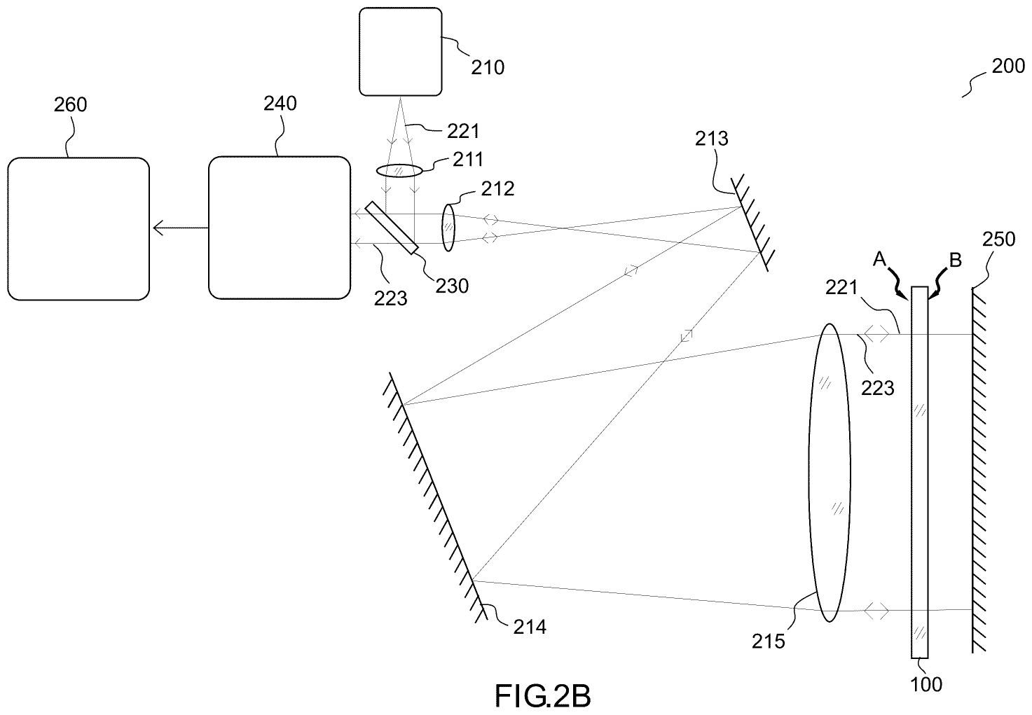

FIGS. 2A and 2B illustrate two steps for the implementation of an example of a method for analyzing the surface quality of a substrate 100 with substantially parallel faces, using a first example of a system for analyzing the surface quality of a substrate. In this example, the aim is to analyze the quality of the two surfaces of a flat substrate with substantially parallel faces.

The system for analyzing the surface quality of a substrate, illustrated in FIGS. 2A and 2B and referenced 200, comprises at least one first support (not shown in the figures), configured for receiving the substrate 100 to be analyzed, and a second support (not shown in the figures) configured for receiving a mirror 250 (FIG. 2B). The mirror is arranged removably, for example, or may be maskable, using a shutter for example, or may be orientable, by a motorized or non-motorized rotation system for example, so that an incident light beam that is subsequently reflected by the mirror is not received by the wavefront analysis means.

The system 200 further comprises light emission means comprising an emission source 210 for light with low temporal coherence, having at least one wavelength to which the substrate 100 is at least partially transparent.

In general terms, the light emission source 210 may comprise an incandescent lamp, a light-emitting diode (LED), a super-luminescent light-emitting diode (SLED) or a laser diode used below its threshold for the generation of the laser effect.

The choice of light source may be matched to the substrate that is to be analyzed. For example, if a spectral filter is analyzed, the light emission source 210 may comprise a super-luminescent diode (SLED) whose wavelength is chosen from the spectral band of transmission of the interference filter.

The system 200 further comprises means of analyzing the wavefront, comprising, in the example of FIGS. 2A and 2B, a wavefront analyzer 240, for example, but not exclusively, a Shack-Hartmann analyzer.

The system 200 further comprises a processing unit 260 configured for processing measurement signals transmitted by the wavefront analyzer 240, and may comprise a display unit (not shown).

In general terms, a processing unit referred to in the present description may comprise one or more physical entities, and may be a combination of elements of one or more computers. Where reference is made in the present description to calculation or processing steps for implementing, notably, steps of methods, it is to be understood that each calculation or processing step may be implemented by software, hardware, firmware, microcode or any appropriate combination of these technologies Where software is used, each calculation or processing step may be implemented by computer program instructions or program code instructions. These instructions may be stored or transmitted to a storage medium readable by the processing unit, and/or may be executed by the processing unit in order to implement these calculation or processing steps.

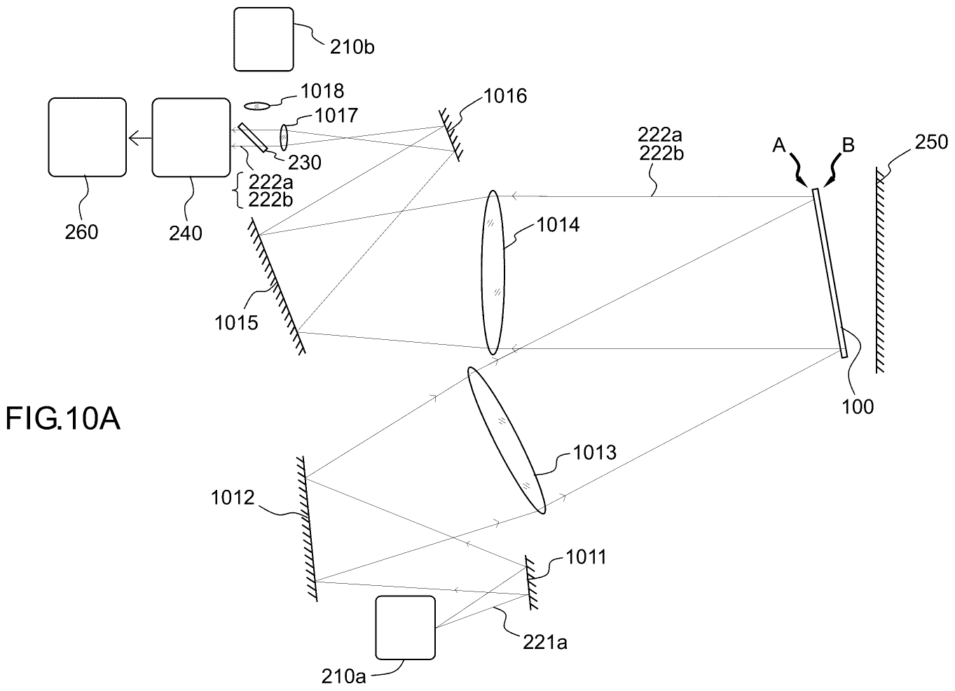

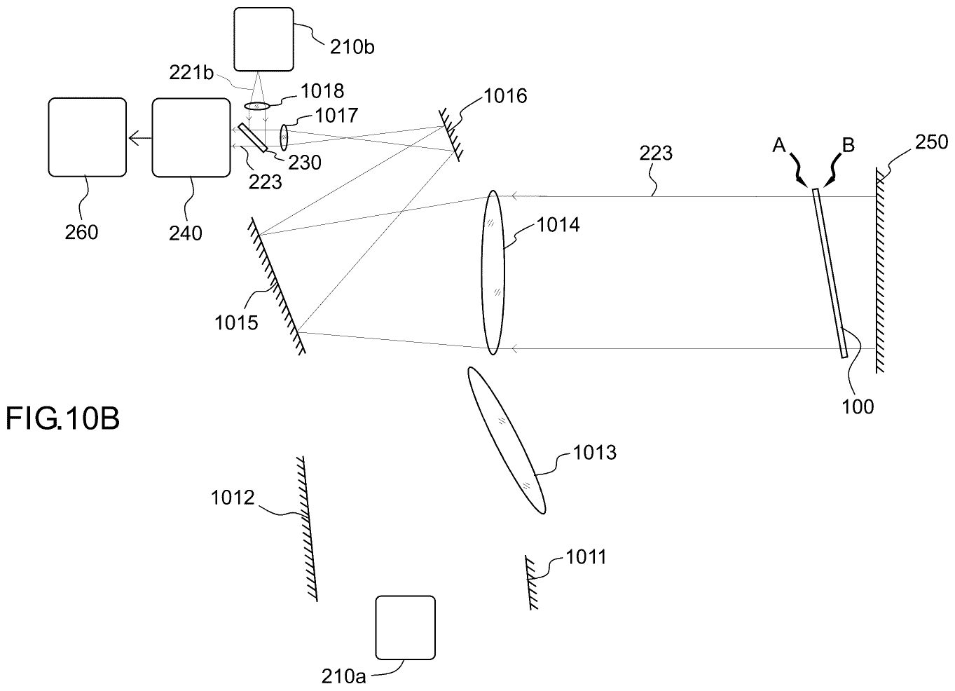

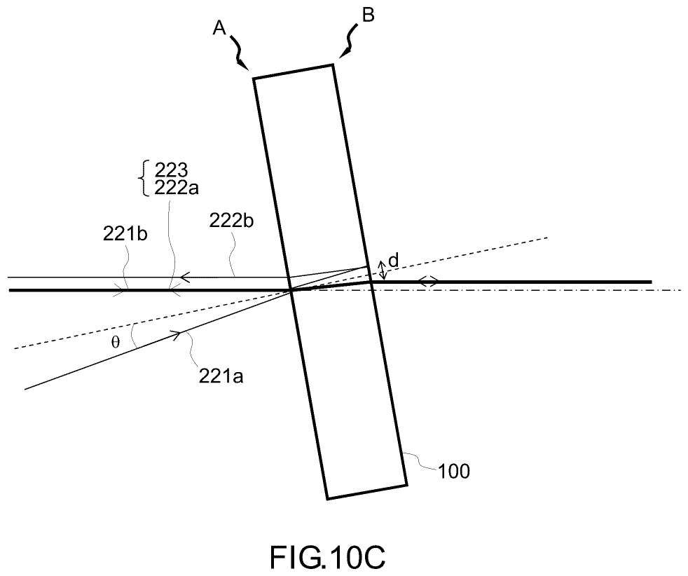

In this example, the light source 210 emits a first light beam 221. In this example, the emission means are configured so that, in operation, the light beam 221 is incident on the substrate in a manner substantially perpendicular to the substrate (normal incidence). Although a normal incidence is preferred, the analysis system can be adapted so that the first light beam is incident at an angle to the normal. An example of this kind is illustrated in FIGS. 10A, 10B and 10C.

In the example of FIGS. 2A and 2B, the aim is to analyze a substantially flat substrate with parallel faces, and the emission means are configured so that, in operation, the light beam is incident on the substrate with a substantially flat wavefront. For example, the emission means comprise, in addition to the source 210, a set of optical lenses 211, 212, 215 and deflection elements 213, 214 enabling the light beam leaving the optical element 215 to be substantially collimated and enabling the size of said beam to be adapted to the size of the substrate to be analyzed. Advantageously, the set of optical lenses further enable an optical conjugation to be substantially provided between the substrate to be analyzed and an analysis plane of the wavefront analyzer, for example the plane of the array of microlenses in the case of a Shack-Hartmann analyzer.

As illustrated in FIG. 2A, in a first step of the method implemented in this example, the first light beam 221 is, on the one hand, reflected by the first face A of the substrate 100 to form a first reflected beam 222a, and, on the other hand, transmitted through the substrate and reflected by the second face B of the substrate 100 and then re-transmitted through the substrate to form a second reflected beam 222b.

The wavefront analysis means are configured for receiving the first reflected beam 222a and the second reflected beam 222b on the analysis surface of the wavefront analyzer 240, in order to generate a first measurement signal characteristic of a combination of the wavefronts of said first and second reflected beams, as will be detailed below.

In the example of FIGS. 2A and 2B, the wavefront analysis means comprise a set of optical lenses 211, 212, 215 and deflection elements 213, 214 common with those of the emission means, to direct the reflected beams toward the wavefront analyzer 240. The system 200 further comprises an optical beam splitting element 230 configured for separating the emission means and the analysis means. The optical element 230 comprises, for example, a beam splitting plate or beam splitting cube.

In this example, the set of optical lenses 211, 212, 215 and deflection elements 213, 214 enable the size of the reflected beams 221a and 221b, and of the transmitted beam 223, to be substantially adapted to the size of the analysis surface of the wavefront analyzer 240. As illustrated in FIG. 2B, in a second step of the method implemented in this example, the reference mirror 250 is installed.

The mirror 250 is arranged in such a way that a second light beam incident on the substrate is incident, after transmission through the substrate, on the mirror 250, in a manner substantially perpendicular to the mirror 250. In this example, the second light beam is emitted by the same light source 210 as the first light beam, and is also referenced 221, because they have the same properties (coherence and wavelength), but the first and second beams are not emitted simultaneously.

The second incident beam is then initially transmitted through the substrate 100, reflected by the reference mirror 250 and re-transmitted through the substrate 100. This results in a transmitted beam 223, sent to the wavefront analyzer 240 of the wavefront analysis means in order to generate a second measurement signal characteristic of the wavefront of said transmitted beam.

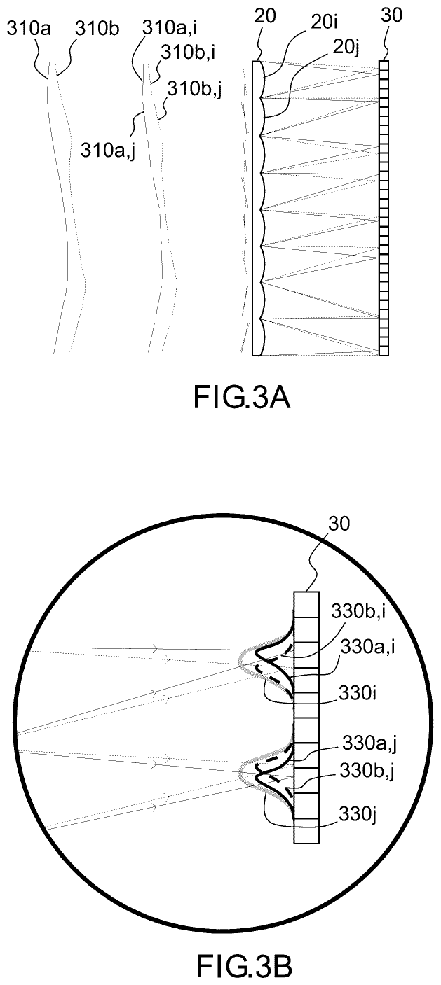

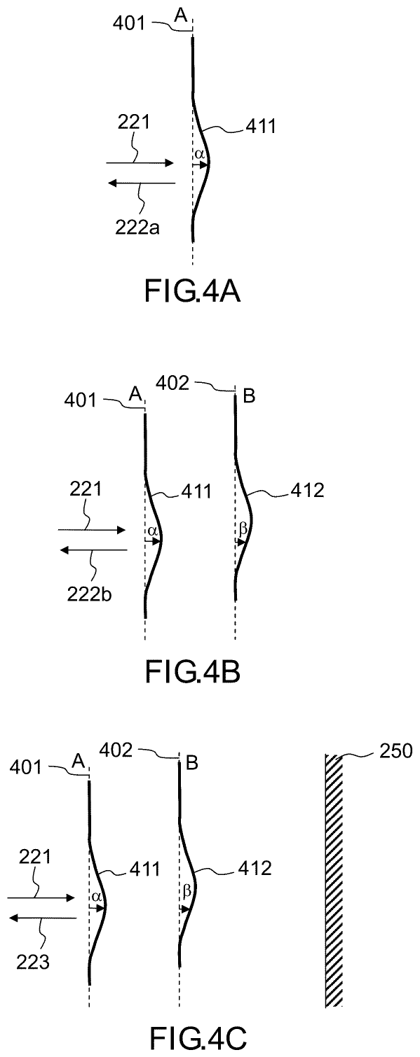

It is then possible to calculate, by means of the processing unit 260 and on the basis of said first measurement signal and said second measurement signal, at least one first signal representative of a deformation of the first face A of the substrate relative to a first reference surface, and at least one second signal representative of a deformation of the second face B of the substrate relative to a second reference surface, as described below with the aid of FIGS. 3A, 3B, 4A, 4B and 4C.

It should be noted that the optical elements of the system 200 may have manufacturing defects, which can be allowed for in a calibration step, in order to avoid interference with the quality of the measurements made. A practical way of performing the calibration is to measure these defects by making a wavefront measurement in the configuration of FIG. 2B from which the substrate 100 to be analyzed has been removed. The defects measured in this way are subtracted from the measurements made (described in detail below) in the presence of the substrate 100 to be analyzed.

For practical purposes, the optical quality of the reference mirror 250 can be chosen on the basis of the desired accuracy of the deformation measurements on the faces A and B of the substrate 100 to be analyzed. This is because the accuracy of these measurements cannot be greater than the optical quality of the reference mirror 250.

The principle of the calculation is described below and is illustrated in FIGS. 3A, 3B, 4A, 4B and 4C.

The principle is described by considering the example of a Shack-Hartmann wavefront analyzer, but is applicable to any type of wavefront analyzer, that is to say any type of measurement system capable of measuring the wavefront directly without the need to make the measurement beam interfere with a reference beam. The common characteristic of these analyzers is their sensitivity to a derivative of the wavefront.

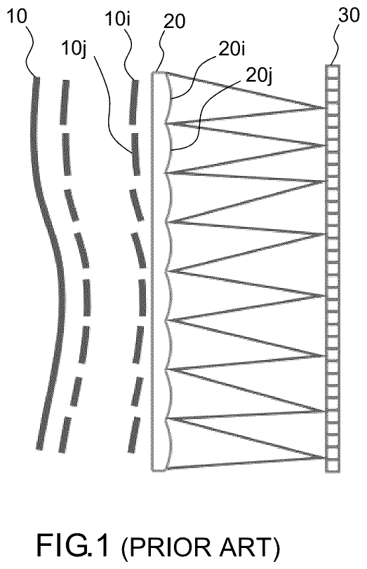

Thus, FIG. 3A illustrates a Shack-Hartmann analyzer identical to that illustrated in FIG. 1, with, notably, an array of microlenses 20 and an array of elementary detectors 30.

The principle is described by considering the example of a substrate to be analyzed with flat and substantially parallel faces. Thus the aim is to find deformations of faces A and B of the substrate relative to flat reference surfaces. As detailed below, however, the principle of the calculation can be applied to other shapes of substrate with parallel faces. In the first step of the example of the method described with the aid of FIGS. 2A and 2B, two reflected beams 222a and 222b are generated, these beams resulting from reflection by faces A and B of the substrate, respectively. As illustrated in FIG. 3A, the wavefront analyzer therefore simultaneously receives the wavefronts 310a and 310b of the reflected beams 222a and 222b respectively. Each wavefront 310a, 310b may be deformed relative to a reference wavefront, for example a flat wavefront.

As illustrated in FIG. 3A, each microlens (20i, 20j, . . . ) of the array of microlenses intercepts and focuses a wavefront part (310a,i, 310a,j . . . ) of the wavefront 310a and intercepts and focuses a wavefront part (310b,i, 310b,j, . . . ) of the wavefront 310b.

As illustrated in FIG. 3B, this results, on the one hand, in a displacement of the barycenter of part of the focal spot (330a,i, 330a,j . . . ) due to the focusing by the microlens (201, 20j, . . . ) of the wavefront part (310a,i, 310a,j, . . . ) of the wavefront 310a and, on the other hand, a displacement of the barycenter of the focal spot (330b,i, 330b,j . . . ) due to the focusing by the microlens (20i, 20j, . . . ) of the wavefront part (310b,i, 310b,j, . . . ) of the wavefront 310b.

In practice, the array of elementary detectors 30 detects for each microlens a distribution of light energy (330i, 330j, . . . ) which is an energy sum of the focal spots (330a,i, 330b,i . . . ) and (330a,j, 330b,j, . . . ). In order to obtain an energy sum of two focal spots 330a,i and 330b,i, the aim is to ensure that the focal spots do not interfere and originate from two beams that are not coherent with each other. This is made possible, in the case of two beams originating from the reflections from the two faces of a substrate with substantially parallel faces, by an illumination source whose coherence length is less than twice the optical thickness of the substrate.

In practical terms, the focal spots (330a,i, 330b,i . . . ) and (330a,j, 330b,j, . . . ) can be superimposed, partially superimposed, or discontinuous. In all cases, the displacement of the resulting light energy distribution (330i, 330j, . . . ) relative to a nominal theoretical position (for example, the position of the focal spots originating from a flat wavefront) is indicative of the local slope of the weighted mean of the wavefronts of the reflected beams 222a and 222b.

If multiple reflections on the substrate are disregarded, it can be determined that the weighting coefficients for establishing said weighted mean are the coefficient of reflection R₁ of the face A for the beam 222a and the coefficient of reflection R₂ of the face B multiplied by the square of the transmission coefficient T of the material from which the substrate is formed and multiplied by the square of (1-R₁) for the beam 222b. (1-R₁) is, on the one hand, the fraction of the illumination beam transmitted in the substrate at the interface between the air and face A and, on the other hand, the fraction of the beam reflected by the face B and transmitted into the air at the interface between face A and the air.

On the basis of the measurement signal thus determined and corresponding to the two-dimensional array of the displacements, it is possible to determine a matrix of the local slopes of the wavefront corresponding to the weighted mean of the reflection wavefronts 222a and 222b, and to deduce therefrom a matrix of the values of the corresponding wavefront, measured at each microlens.

With the aid of FIGS. 4A, 4B and 4C, a more detailed description will now be given of the way in which the deformation matrices α and β of the faces A and B can be determined relative to flat reference surfaces, in a non-limiting example provided for illustrative purposes.

FIGS. 4A and 4B correspond to the first step of the method as described with reference to FIG. 2A.

FIG. 4A illustrates a local deformation α of face A relative to a reference surface 401, which is a flat surface in this example.

The reflected beam 222a resulting from the reflection of the incident beam 221 by the face A undergoes a local variation of the optical path δ.

$$δ = 2 α \qquad [ Math 1 ]$$

FIG. 4B illustrates both faces A and B of the substrate 100.

FIG. 4B also illustrates, in addition to the local deformation of face A, a local deformation β of face B relative to a reference surface 402, which is a flat surface in this example. The reflected beam 222b, resulting from transmission through the substrate of the first light beam 221, followed by reflection from face B, before re-transmission through the substrate, undergoes a local variation of the optical path δ:

$$δ = 2 [ α - n α + n β ] \qquad [ Math 2 ]$$

where n is the refractive index of the material of the substrate, which is considered to be substantially constant in this example.

The reflected beams 222a and 222b, whose wavefronts are locally deformed as explained above because of the local deformations of faces A and B relative to their reference surface, are received simultaneously by the wavefront analyzer, as illustrated in FIGS. 3A and 3B.

This results in a first measurement signal in matrix form M₁, characteristic of the weighted mean of the wavefronts of said first 222a and second 222b reflected beams. The weighting coefficients are R₁ and R₂*T²*(1-R₁)² respectively:

$${M}_{1} = \frac{[ 2 α ( {R}_{1} + {{R}_{2} ( 1 - {R}_{1} )}^{2} {T}^{2} ) - 2 {{R}_{2} ( 1 - {R}_{1} )}^{2} {T}^{2} n ( α - β ) ]}{{R}_{1} + {{R}_{2} ( 1 - {R}_{1} )}^{2} {T}^{2}} \qquad [ Math 3 ]$$

where R₁ and R₂ are the reflection coefficients of face A and face B respectively, assumed to be constant, T is the transmission coefficient of the substrate material, assumed to be constant, and α and β are the matrices of deformations of faces A and B.

FIG. 4C corresponds to the second step of the method as described with reference to FIG. 2B.

In this example, the transmitted beam 223, resulting from a first transmission through the substrate of the second light beam, the reflection by the mirror 250 arranged in a manner substantially perpendicular to the light beam, and then a second transmission through the substrate, undergoes a local variation of the optical path &:

$$δ = 2 ( n - 1 ) ( β - α ) \qquad [ Math 4 ]$$

The transmitted beam 223, whose wavefront is locally deformed as explained above because of the local deformations of faces A and B, is received by the wavefront analyzer 240.

This results in a second measurement signal in matrix form M₂, characteristic of the wavefront of the transmitted beam.

$${M}_{2} = 2 ( n - 1 ) ( β - α ) \qquad [ Math 5 ]$$

From the measurements M₁ and M₂, the deformation matrices α and β relative to their reference surface can be deduced:

$$α = \frac{{M}_{1}}{2} - ( \frac{{n ( 1 - {R}_{1} )}^{2} {T}^{2} {R}_{2} {M}_{2}}{2 ( n - 1 ) ( {R}_{1} + {( 1 - {R}_{1} )}^{2} {T}^{2} {R}_{2} )} ) \qquad [ Math 6 ]$$

$$and$$

$$β = α + ( \frac{{M}_{2}}{2 ( n - 1 )} ) \qquad [ Math 7 ]$$

It should be noted that, α and β being the deformations of faces A and B relative to reference surfaces, the profiles of faces A and B themselves can be found simply by adding the deformations α and β to their respective reference surfaces.

In the calculations given above, it is assumed, in the calculation of M₁, that the effect of multiple reflections within the substrate is negligible. This is reasonable where the reflection coefficients of the faces of the substrate are less than or equal to about 10%, because in this case the contribution of multiple reflections to the measurement is less than 1% of the signal received by the wavefront analyzer.

For cases where the reflection coefficients are greater than 10%, multiple reflections can be allowed for in the equation [Math 3] without any particular difficulty, resulting in a considerably more complex numerical expression which is not reproduced here.

Additionally, M₂ is determined on the assumption that this measurement is not perturbed by any signal originating from reflections from the faces of the substrate. This assumption is usually acceptable, since the reflection signal is much weaker than the transmission signal. However, the reflection signal can be dispensed with in the measurement of M₂ by tilting the substrate through a few degrees, so as to reject the reflections outside the measurement area. Alternatively, the reflection signals can be subtracted from the measurement signal originating from the transmitted beam. It is also possible, without any particular difficulty, to allow for the presence of reflections in the numerical expression of the measurement M₂ given by [Math 5], which again results in a more complex numerical expression of M₂.

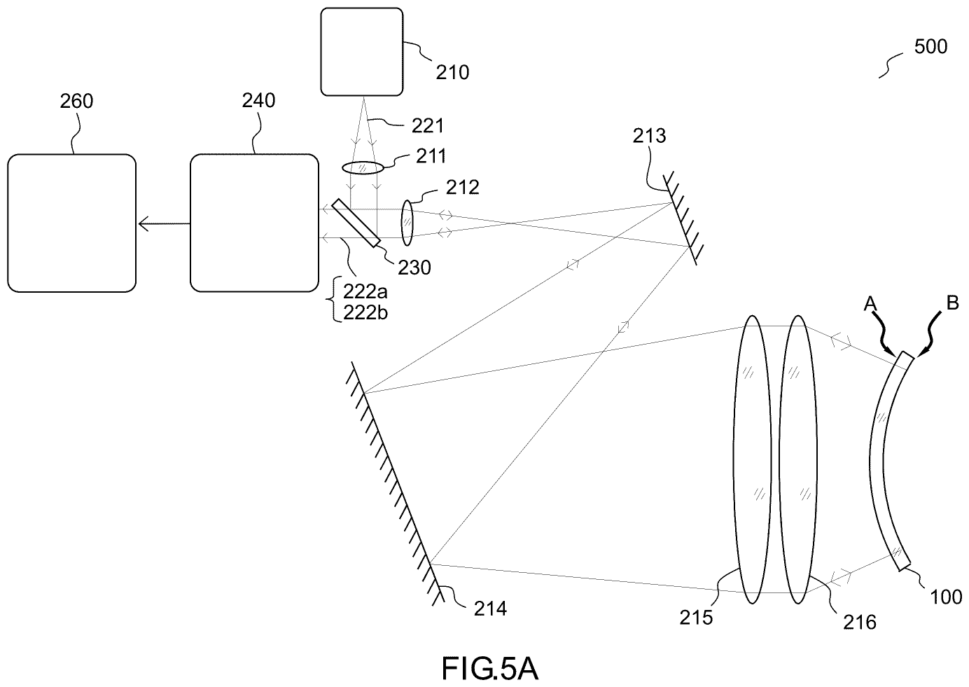

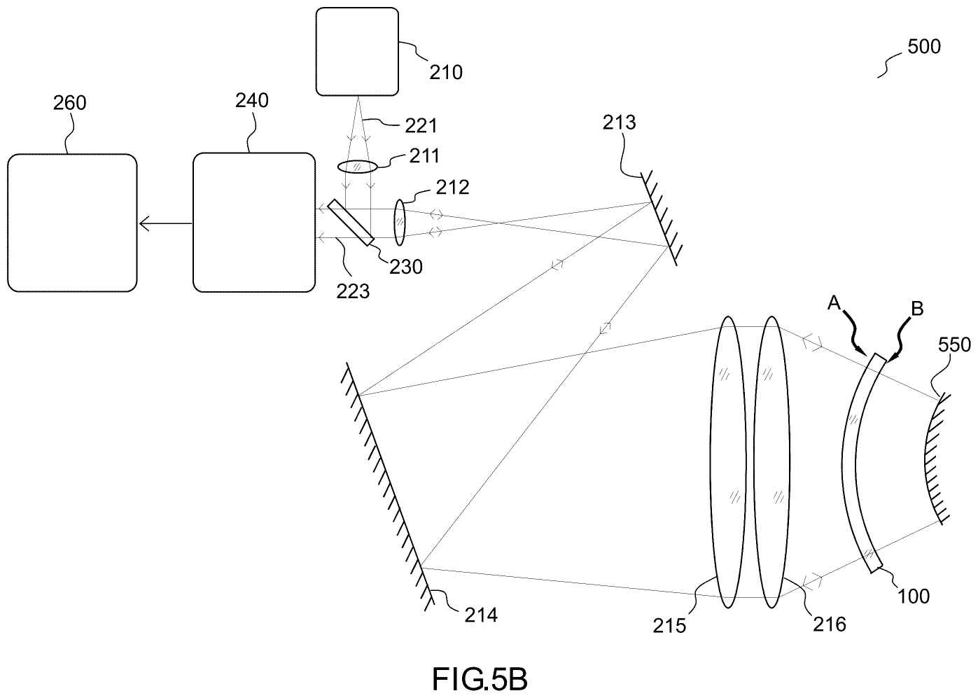

FIGS. 5A and 5B illustrate two steps for the implementation of an example of a method for analyzing the surface quality of a substrate 100 with parallel faces, using a second example of a system for analyzing the surface quality of a substrate. In this example, the aim is to analyze the quality of a surface of a substrate that is not flat, in other words one having a given non-zero curvature, locally at least.

Thus, in the example illustrated in FIGS. 5A and SB, the aim is to analyze the surface quality of faces A and B of a substrate 100 with parallel faces, where the faces of the substrate have a substantially constant finite radius of curvature. Such a substrate is, for example, a protective dome. The radii of curvature of the faces of such substrates are usually between several centimeters and several meters.

The system 500 for analyzing the surface quality is substantially identical to that illustrated in FIGS. 2A and 2B, only the optical elements common to the emission means and wavefront analysis means being adapted so that the first light beam 221 emitted by the source 210 is incident on the substrate 100 in a manner substantially perpendicular to the faces of the substrate, which are not flat in this example. The reference wavefront with which the wavefront measurements are compared is a spherical wavefront in this example. Similarly, the reference surfaces relative to which the deformations of faces A and B of the substrate are analyzed are spherical reference surfaces.

Thus, the emission means in this example comprise an additional optical lens 216 for shaping the light beam 221 so that it is substantially perpendicular at all points to the substrate 100 to be analyzed, and for substantially establishing an optical conjugation between the substrate to be analyzed and the analysis surface of the wavefront analyzer. Additionally, the radius of curvature and the position of the reference mirror 550 are chosen so that this mirror is substantially perpendicular at all points to the light beam 221. In practice, because of the optical elements 216, 215, 230 and the mirrors 213 and 214, the wavefronts of the reflected beams 222a and 222b received by the wavefront analyzer 240 are substantially flat, as in the example described previously, except as regards the deformations due to the deformations of faces A and B of the substrate 100. This is because the optical elements 216, 215, 230 and the mirrors 213 and 214 convert the spherical reference wavefront at the position of the substrate to be analyzed into a flat reference wavefront at the wavefront analyzer, as in the example described previously. A similar process can therefore be executed to determine the deformation matrices of faces A and B.

It should be noted that it would also be feasible to receive the spherical wavefronts directly at the wavefront analyzer, in which case the reference wavefront at the wavefront analyzer would be spherical.

It should be noted that the optical elements of the system 500 may have manufacturing defects, which can be allowed for in a calibration step, in order to avoid interference with the quality of the measurements made A practical way of doing this is to measure these defects by making a wavefront measurement in the configuration of FIG. 5B from which the substrate 100 to be analyzed has been removed. The defects measured in this way are subtracted from the measurements made in the presence of the substrate 100 to be analyzed.

For practical purposes, the optical quality of the reference mirror 550 can be chosen on the basis of the desired accuracy of the deformation measurements on faces A and B of the substrate 100 to be analyzed. This is because the accuracy of these measurements cannot be greater than the optical quality of the reference mirror 550.

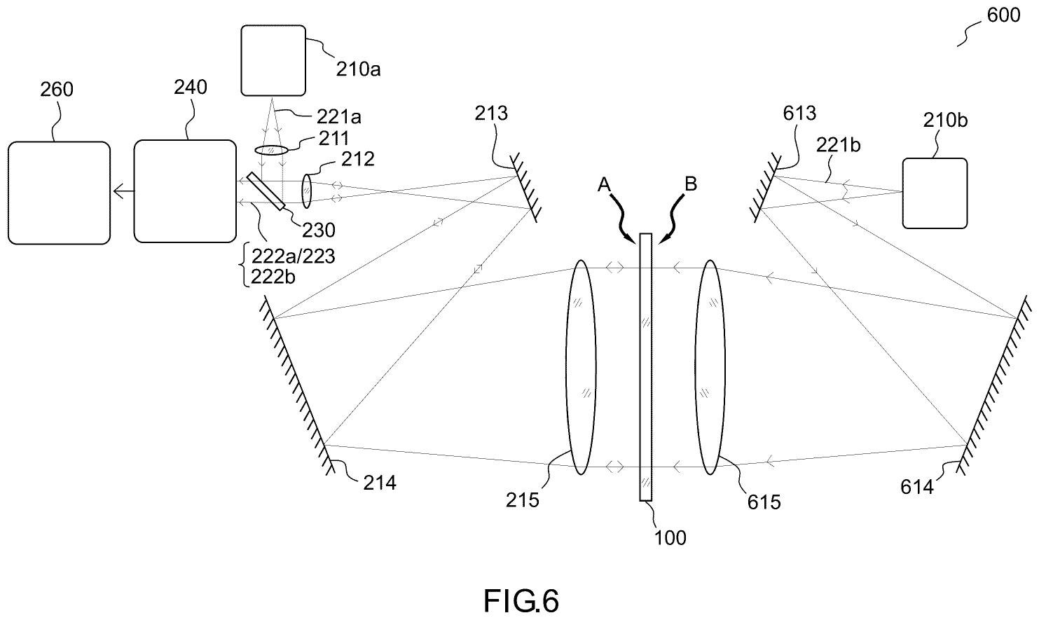

FIG. 6 illustrates the implementation of another example of a method for analyzing the surface quality of a substrate 100 with parallel faces according to the present description, using a second example of a system for analyzing the surface quality of a substrate. In this example, the aim is to analyze the quality of a surface of a flat substrate 100 with parallel faces.

The system for analyzing the surface quality of a substrate, illustrated in FIG. 6 and referenced 600, comprises a support (not shown in the figures) configured for receiving the substrate 100 to be analyzed, but does not require a reference mirror as in the examples illustrated in FIGS. 2A, 2B, 5A, 5B, except for a possible calibration procedure, as will be described subsequently.

The system 600 comprises light emission means comprising, in this example, a first emission source 210a for light with low temporal coherence, having at least one wavelength to which the substrate 100 is at least partially transparent. For example, the light emission source 210a may comprise, as before, an incandescent lamp, an LED, an SLED, or a laser diode operating below the laser effect generation threshold.

The emission means also comprise a second emission source 210b having at least one wavelength to which the substrate 100 is at least partially transparent. Unlike the source 210a, the source 210b does not need to have a low coherence length, which extends the possibilities. Thus this light source 210b may comprise, as before, an incandescent lamp, an LED, an SLED, or a laser diode operating below the laser effect generation threshold, or indeed a laser or a laser diode operating above its laser effect generation threshold.

The aforesaid sources have the advantage of being spatially coherent.

As a general rule, spatially coherent light sources can be chosen for the emission of the first and second light beams. This is because greater measurement accuracy for the wavefront analysis is achieved with spatially coherent beams.

If, for example, a Shack-Hartmann wavefront analyzer is used, the first and second light beams may have sufficient spatial coherence for the resulting reflected or transmitted beams, incident on the microlens array, to generate focal spots whose size is smaller than the size of the microlenses generating them.

The system 600 further comprises wavefront analysis means comprising, in the example of FIG. 6, a wavefront analyzer 240, for example but not exclusively a Shack-Hartmann analyzer, and a processing unit 260 configured for processing measurement signals emitted by the wavefront analyzer 240.

In this example, the first light source 210a emits a first light beam 221a. The emission means are configured so that, in operation, the first light beam 221a is incident on one face of the substrate, in this example face A, advantageously in a manner substantially perpendicular to the substrate. In the example of FIG. 6, the aim is to analyze a substantially flat substrate with parallel faces, and the emission means are configured so that, in operation, the light beam is incident on the substrate with a substantially flat wavefront. For example, the emission means comprise, as in the preceding examples, a set of optical lenses 211, 212, 215 and deflection elements 213, 214, in addition to the source 210a.

In this example, the second light source 210b emits a second light beam 221b. The emission means are configured so that, in operation, the second light beam 221b is incident on the other face of the substrate, which in this example is face B, for example, but not necessarily, in a manner substantially perpendicular to the substrate. In the example of FIG. 6, the aim is to analyze a substantially flat substrate with parallel faces, and the emission means are configured so that, in operation, the second light beam is incident on the substrate with a substantially flat wavefront. For example, the emission means comprise, in addition to the source 210b, a set of optical lenses 615 and deflection elements 613, 614, for substantially collimating the beam and adapting its size to the size of the substrate to be analyzed.

As illustrated in FIG. 6, in a first step of the method implemented in this example, the source 210a is activated and the first incident light beam 221a is, on the one hand, reflected by the first face A of the substrate 100 to form a first reflected beam 222a, and, on the other hand, transmitted through the substrate, reflected by the second face B of the substrate 100 and re-transmitted through the substrate 100 to form a second reflected beam 222b.

The wavefront analysis means are configured for receiving the first reflected beam 222a and the second reflected beam 222b, in order to generate a first measurement signal characteristic of a combination of the wavefronts of said first and second reflected beams, as has been described previously.

In the example of FIG. 6, the wavefront analysis means comprise, as in the preceding example, a set of optical lenses 211, 212, 215 and deflection elements 213, 214 common with those of the emission means, to direct the reflected beams toward the wavefront analyzer 240. The system 200 further comprises, as before, an optical beam splitting element 230 configured for separating the emission means and the analysis means.

In a second step of the method implemented in this example, the source 210b is activated while the source 210a is switched off and the second light beam 221b is transmitted through the substrate 100. This results in a transmitted beam 223, sent to the wavefront analyzer 240 of the wavefront analysis means in order to generate a second measurement signal characteristic of the wavefront of said transmitted beam.

It is then possible to calculate, by means of the processing unit 260 and on the basis of said first measurement signal and said second measurement signal, at least one first signal representative of a deformation of the first face A of the substrate relative to a first reference surface, and at least one second signal representative of a deformation of the second face B of the substrate relative to a second reference surface, as described above with the aid of FIGS. 3A, 3B, 4A, 4B and 4C.

It should be noted that, because of the simple passage through the substrate, [Math 5] becomes:

$${M}_{2} = ( n - 1 ) ( β - α ) \qquad [ Math 8 ]$$

As explained with reference to the preceding examples, the optical elements of the system 600 may have manufacturing defects, which can be allowed for in a calibration step, in order to avoid interference with the quality of the measurements made. Two calibration steps can be implemented. These are a first calibration step for the transmitted beam and a second calibration step for the reflected beam. A practical way of performing the step of calibrating the transmitted beam is to measure the defects of the optics by making a wavefront measurement in the configuration of FIG. 6 with the source 210b switched on (source 210a is off), from which the substrate 100 to be analyzed has been removed. These defects, measured in this way, are then subtracted from the transmission measurements made in the presence of the substrate 100 to be analyzed. The step of calibrating the beam in reflection is identical to the calibration described for FIGS. 2A and 2B, where the substrate is replaced with a reference mirror (the source 210a is switched on and the source 210b is switched off).

Although it is illustrated in the case of the analysis of a flat substrate, the method described with the aid of FIG. 6 can be adapted to the analysis of a curved substrate. For this purpose, the optical elements 615, 614, 613, notably, must be adapted, for example so that the image of the emission source 210b formed by the optical elements is located substantially in the center of curvature of the substrate to be analyzed.

By comparison with the examples of embodiment of FIGS. 2A, 2B, 5A and 5B, the methods for analyzing the surface quality of a substrate implemented with a system such as that shown in FIG. 6 may be faster, since there is no need to install a reference mirror for the measurement itself, because a reference mirror is only useful for the calibration procedures.

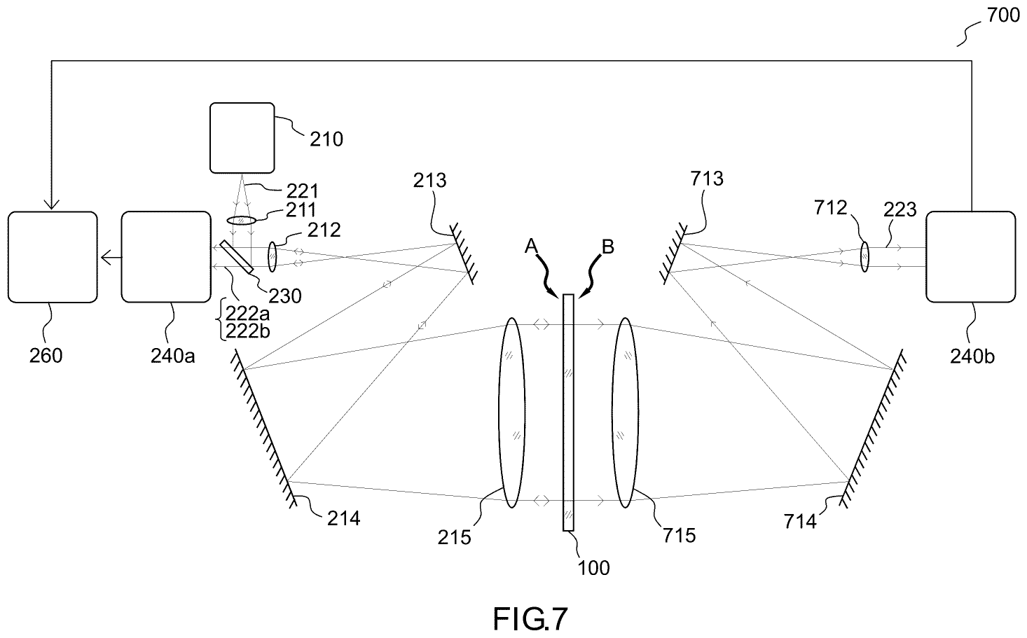

In examples of embodiment (not shown in the figures), the system described in FIG. 6 may incorporate an additional light source in parallel with the second source 210b, using a separating plate, a separating cube or a dichroic plate, for example. This additional light source may emit a third light beam whose wavelength and/or polarization is different from the second light beam emitted for the source 210b. This third light beam generates a second transmitted beam and follows an optical path identical to that of the second light beam that generates the first transmitted beam. The second transmitted beam is received by the analyzer 240 to generate a third measurement signal characteristic of the wavefront of said second transmitted beam. A comparison of the second measurement signal characteristic of the wavefront of the first transmitted beam and the third measurement signal characteristic of the wavefront of the second transmitted beam can be used to generate a signal characteristic of the variations of the refractive index within the substrate. FIG. 7 illustrates the implementation of another example of a method for analyzing the surface quality of a substrate 100 with parallel faces according to the present description, using a third example of a system for analyzing the surface quality of a substrate. In this example, the two steps of the method, for obtaining the first and the second method respectively, may be executed simultaneously. In this example, the aim is to analyze the quality of a surface of a substrate 100 with substantially flat parallel faces.

The system for analyzing the surface quality of a substrate, illustrated in FIG. 7 and referenced 700, comprises a support (not shown in the figures) configured for receiving the substrate 100 to be analyzed, but does not require a reference mirror as in the examples illustrated in FIGS. 2A, 2B, 5A, 5B, except for possible calibration, as will be described subsequently.

The system 700 comprises light emission means comprising, in this example, and as in the examples of FIGS. 2A, 2B, 5A and 5B, a single emission source 210 for light with low temporal coherence, having at least one wavelength to which the substrate 100 is at least partially transparent. For example, the light emission source 210 may comprise, as before, an incandescent lamp, an LED, an SLED, or a laser diode operating below the laser effect generation threshold.

The system 700 further comprises wavefront analysis means comprising, in the example of FIG. 7, a first wavefront analyzer 240a and a second wavefront analyzer 240b separate from the first wavefront analyzer 240a, these analyzers being, for example but not exclusively, Shack-Hartmann analyzers, and a processing unit 260 configured for processing measurement signals emitted by the wavefront analyzers 240a and 240b Advantageously, the wavefront analyzers are of identical types, but wavefront analyzers of different types can be used.

In this example, the light source 210 emits a first light beam 221. The emission means are configured so that, in operation, the first light beam 221 is incident on one face of the substrate, in this example face A, in a manner substantially perpendicular to the substrate.

In the example of FIG. 7, the aim is to analyze a substrate with substantially flat parallel faces, and the emission means are configured so that, in operation, the light beam is incident on the substrate with a substantially flat wavefront. For example, the emission means comprise, as in the preceding examples, a set of optical lenses 211, 212, 215 and deflection elements 213, 214, in addition to the source 210.

As illustrated in FIG. 7, in a first step of the method implemented in this example, the source 210 is activated and the first incident light beam 221 is, on the one hand, reflected by the first face A of the substrate 100 to form a first reflected beam 222a, and, on the other hand, transmitted through the substrate, then reflected by the second face B of the substrate 100 and re-transmitted through the substrate 100 to form a second reflected beam 222b.

The wavefront analysis means are configured for receiving the first reflected beam 222a and the second reflected beam 222b, in order to generate a first measurement signal characteristic of a combination of the wavefronts of said first and second reflected beams, as has been described previously.

In the example of FIG. 7, the wavefront analysis means comprise, as in the preceding example, a set of optical lenses 211, 212, 215 and deflection elements 213, 214 common with those of the emission means, to direct the reflected beams toward the wavefront analyzer 240a and to substantially establish an optical conjugation between the substrate 100 to be analyzed and the measurement surface of the wavefront analyzer 240a. The system 700 further comprises, as before, an optical beam splitting element 230 configured for separating the emission means and the wavefront analyzer 240a.

In a second step of the method implemented in this example, which may be simultaneous with the first step, a transmitted beam 223, resulting from the transmission through the substrate of a second light beam which may coincide with the first light beam 221, is sent to the second wavefront analyzer 240b of the wavefront analysis means, in order to generate a second measurement signal characteristic of the wavefront of said transmitted beam.

In the example of FIG. 7, the wavefront analysis means comprise a set of optical lenses 715, 712 and deflection elements 714, 713 to direct the transmitted beam 223 toward the wavefront analyzer 240b and to substantially establish an optical conjugation between the substrate 100 to be analyzed and the measurement surface of the wavefront analyzer 240b. It is then possible to calculate, by means of the processing unit 260 and on the basis of said first measurement signal and said second measurement signal, at least one first signal representative of a deformation of the first face A of the substrate relative to a first reference surface, and at least one second signal representative of a deformation of the second face B of the substrate relative to a second reference surface, as described above with the aid of FIGS. 3A, 3B, 4A, 4B and 4C.

As in the example of FIG. 6, because of the simple transmission through the substrate of the second light beam, the equation [math 8] is applicable.

As before, the optical elements of the system 700 may have manufacturing defects, which can be allowed for in a calibration step, in order to avoid interference with the quality of the measurements made. Two calibration steps can be provided. These are a calibration step for the transmitted beam and a calibration step for the reflected beam. A practical way of performing the step of calibrating the transmitted beam is to measure the defects of the optics with the analyzer 240b by making a wavefront measurement in the configuration of FIG. 7 with the source 210 switched on, from which the substrate 100 to be analyzed has been removed. These defects, measured in this way, are then subtracted from the transmission measurements made in the presence of the substrate 100 to be analyzed. The step of calibrating the beam in reflection is identical to the calibration described for FIGS. 2A and 2B, where the substrate is replaced with a reference mirror.

Although it is illustrated in the case of the analysis of a flat substrate, the method described with the aid of FIG. 7 can be adapted to the analysis of a curved substrate. For this purpose, the optical elements 211 to 215 must be adapted, for example so as to adapt the size of the beam 221 to the size of the substrate to be analyzed, in order to ensure that the beam 221 arrives in a substantially perpendicular manner on the surface of the substrate to be analyzed, and that an optical conjugation is substantially established between the substrate 100 to be analyzed and the measurement surface of the wavefront analyzer 240a. The optical elements 715, 714 and 713 must also be adapted, for example so as to adapt the size of the transmitted beam at the substrate 100 to be analyzed to the size of the measurement surface of the analyzer 240b, and to substantially establish an optical conjugation between the substrate 100 to be analyzed and the measurement surface of the wavefront analyzer 240b.

By comparison with the examples of embodiment of FIGS. 2A, 2B, 5A and 5B, the methods for analyzing the surface quality of a substrate implemented with a system such as that shown in FIG. 7 may be faster, since there is no need to install a reference mirror for the measurement itself, because a reference mirror is only useful for the calibration procedures. Furthermore, the measurements of M₁ and M₂ can be made simultaneously, owing to the presence of the two wavefront analyzers, since the first and second reflected beams 221a, 221b, together with the transmitted beam 223, can be generated simultaneously from the light beam 221.

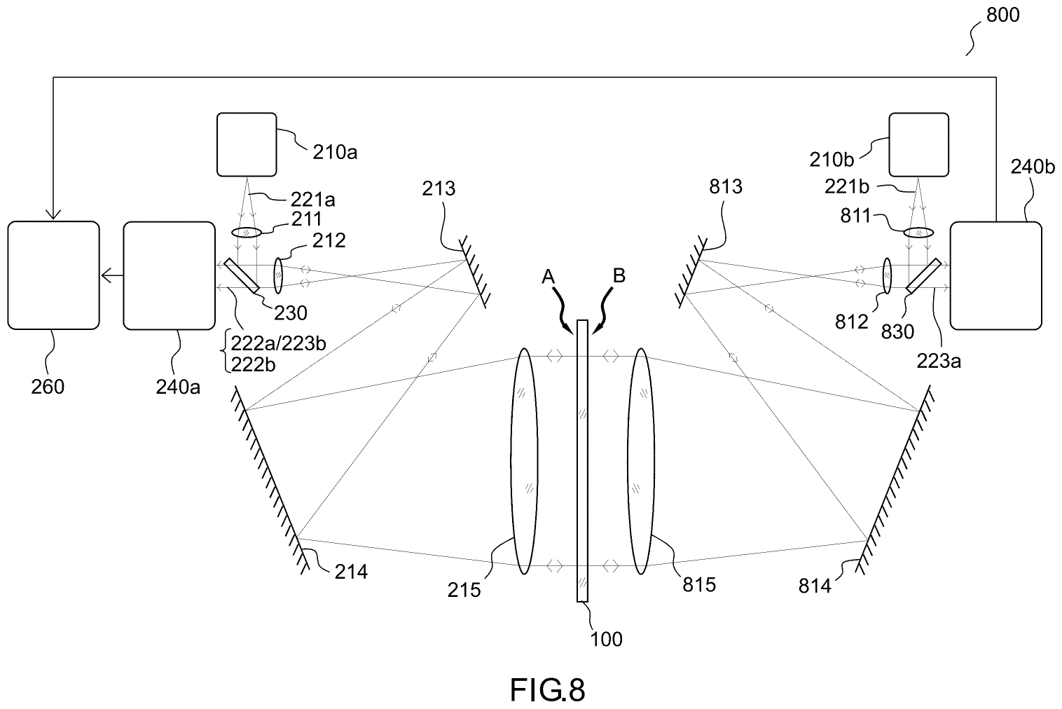

FIG. 8 illustrates a system 800 comprising, as in the example of FIG. 6, emission means with a first emission source 210a and a second emission source 210b, separate from the first source. The system 800 also comprises, as in the example of FIG. 7, wavefront analysis means comprising a first wavefront analyzer 240a and a second wavefront analyzer 240b, separate from the first wavefront analyzer 240a. The system 800 further comprises a processing unit 260, configured for processing measurement signals produced by the wavefront analyzers 240a and 240b.

Such a system has advantages similar to those of the system of FIG. 7, namely that a single light beam 221a emitted by the first source 210a can simultaneously produce the reflected beams 222a and 222b detected by the first wavefront analyzer 240a to generate the first measurement signal characteristic of a combination of the wavefronts of said first and second reflected beams, and produce the first transmitted beam 223a detected by the second wavefront analyzer 240b to produce the second measurement signal characteristic of the wavefront of said transmitted beam.

For this purpose, the wavefront analysis means may comprise, as in the preceding example, a set of optical lenses 211, 212, 215 and deflection elements 213, 214 common with those of the emission means, to direct the reflected beams toward the wavefront analyzer 240a and to substantially establish an optical conjugation between the substrate 100 to be analyzed and the measurement surface of the wavefront analyzer 240a. The system 800 may further comprise, as before, an optical beam splitting element 230 configured for separating the emission means and the wavefront analyzer 240a. Additionally, in the example of FIG. 8, the wavefront analysis means comprise a set of optical lenses 815, 812 and deflection elements 814, 813 to direct the transmitted beam 223a toward the second wavefront analyzer 240b and to substantially establish an optical conjugation between the substrate 100 to be analyzed and the measurement surface of the wavefront analyzer 240b. Further, in this example, the second light source 210b is configured for emitting a second light beam 221b that has a different wavelength and/or polarization from those of the first light beam 221a.

The method may then comprise, in one example of embodiment, receiving, by the first wavefront analyzer 240a, a second transmitted beam 223b resulting from a first transmission through the substrate of said second light beam 221b, in order to generate a third measurement signal characteristic of the wavefront of said second transmitted beam. A comparison of the second measurement signal characteristic of the wavefront of the first transmitted beam and the third measurement signal characteristic of the wavefront of the second transmitted beam can be used to generate a signal characteristic of the variations of the refractive index within the substrate.

As illustrated in FIG. 8, the emission means may comprise optical elements 811 and 812-815 that are common with the analysis means, as well as a separating element 830 for sending the second light beam 221b toward the substrate 100, for example, but not necessarily, with a normal incidence.

Calibration procedures may be performed, such as those described in relation to the preceding figures.

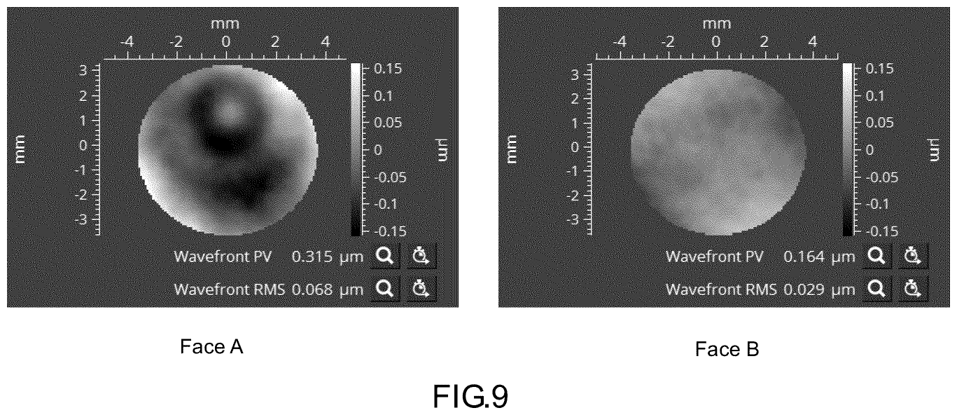

FIG. 9 illustrates experimental images representing the deformations of faces of a flat substrate with parallel faces, the images being obtained by a method according to the present description.

More precisely, in this example, the substrate is a substrate with flat parallel faces, 3 mm thick, resulting from double-face polishing, and one of the 2 faces (face A) has polishing faults.

The system used for the analysis is a system of the type illustrated in FIGS. 2A and 2B. The emission source is a laser diode injected into a monomode fiber used below the laser effect generation threshold, and the wavefront analyzer is a Shack-Hartmann analyzer.

The deformation matrices are found by means of the formulae [Math 6] and [Math 7], on the basis of a first measurement signal M₁, characteristic of a combination of the wavefronts of the first and second reflected beams, and a second measurement signal M₂, characteristic of the wavefront of the transmitted beam, as explained with reference to FIGS. 2A and 2B.

The substrate is analyzed and the matrices of the deformations α and β of the faces A and B relative to flat reference surfaces are determined and illustrated in the left- and right-hand images, respectively, of FIG. 9.

Polishing faults are observed, notably, on face A, with a P-V (peak to valley) amplitude of 0.315 μm. This test demonstrates that the method clearly enables the 2 faces to be measured separately, since the measurement of face B shows no polishing fault, which was to be expected on this substrate which has polishing faults on one of its faces only.

In the examples of embodiment described with the aid of FIGS. 2A, 2B, 6, 7 and 8, a first light beam, incident in a substantially perpendicular manner on the substrate to be analyzed, was considered.

Although this is an advantageous configuration, those skilled in the art will be able to envisage other embodiments, notably those suitable for the use of an inclined substrate. Thus FIG. 10A shows a diagram illustrating a first step of an example of a method for analyzing the surface quality of a substrate according to the present description, using an example of a system for analyzing the surface quality of a substrate according to the present description, adapted for an incidence of the first light beam on the substrate with a non-zero angle of inclination relative to the normal, and FIG. 10B shows a diagram illustrating a second step of the example of the method for analyzing the surface quality of the substrate. In this example, a reference mirror 250 is used, as in the example of FIGS. 2A and 2B.

The emission means in this example comprise two light emission sources, namely 210a for the emission of the first light beam 221a with low temporal coherence (FIG. 10A) and 210b for the emission of the second light beam 221b (FIG. 10B).

The emission means also comprise, as illustrated in FIGS. 10A and 10B, a set of optical lenses 1013, 1018, 1017, 1014 and deflection elements 1011, 1012, 1016, 1015, for directing the first light beam emitted by the first source 210a and the second light beam emitted by the second source 210b toward the substrate 100.

In this example, the analysis means comprise a set of optical lenses 1014, 1017, 1018 and deflection elements 1015, 1016 common with those of the emission means, to direct the reflected beams 222a, 222b toward the first wavefront analyzer 240a and to substantially establish an optical conjugation between the substrate 100 to be analyzed and the measurement surface of the wavefront analyzer 240a. A separator element 230 enables the analysis path to be separated from the emission path.

As illustrated in FIG. 10C, the system described with reference to FIGS. 10A and 10B can be used to analyze an inclined substrate, within certain limits. Notably, if the angle θ of inclination of the first light beam 221a relative to the normal to the substrate is too large, this may result, notably in the case of a thick substrate, in a spatial offset denoted d between the footprint of the defects of face B on the reflected beam 222b and their footprints on the transmitted beam, and this can distort the calculation of the deformations of faces A and B from the measurements in reflection and transmission. Those skilled in the art, with knowledge of this field, will be capable of adapting the optical assembly in order to limit the inclination of the first light beam according to the thickness of the substrate, so that the offset d is small relative to the spatial period of the expected defects of face B and the spatial resolution of the wavefront analyzer.

Although it has been described in the form of a certain number of exemplary embodiments, the systems and methods according to the present description incorporate different variants, modifications and improvements which will be evident to a person skilled in the art, these different variants, modifications and improvements being considered to lie within the scope of the invention as defined by the following claims.

### REFERENCES

Ref. 1: Craig R. Forest et al., Metrology of thin transparent optics Shack-Hartmann wavefront sensing, Optical Engineering, 43 (3), 2004, https://doi.org/10.1117/1.1645256.
Ref. 2: WO 2004/068088
Ref. 3: Principles and History of Shack-Hartmann, Journal of Refractive Surgery Volume 17, September/October 2001.
Ref. 4: U.S. Pat. No. 6,577,403
Ref. 5: US20100310130
Ref. 6: US20050036153

1. A method for analyzing the surface quality of a substrate with parallel faces, comprising:
emitting, by at least one first light source of emission means, at least one first light beam with low temporal coherence, said at least one first light beam being incident on a first face of said substrate, said substrate being at least partially transparent to at least one wavelength of said first light beam;
receiving, by at least one first wavefront analyzer of wavefront analysis means, at least one first reflected beam and a second reflected beam, said first reflected beam resulting from reflection of said at least one first light beam by said first face of the substrate and said second reflected beam resulting from a first transmission through the substrate of said first light beam and then a reflection by a second face of the substrate, followed by a second transmission through the substrate, in order to generate at least one first measurement signal characteristic of a combination of the wavefronts of said first and second reflected beams;
receiving, by said wavefront analysis means, at least one first transmitted beam resulting from at least one first transmission through the substrate of a second light beam emitted by said emission means, in order to generate a second measurement signal characteristic of the wavefront of said transmitted beam;
calculating, from said at least one first measurement signal and said second measurement signal, at least one first signal representative of a deformation of said first face of the substrate relative to a first reference surface and at least one second signal representative of a deformation of the second face of the substrate relative to a second reference surface.

2. The method as claimed in claim 1, wherein said at least one first light beam is incident on said substrate in a manner substantially perpendicular to said substrate.

3. The method as claimed in claim 1, wherein:
said second light beam is incident on said first face of the substrate and the method further comprises, for the generation of the second measurement signal:
positioning a reference mirror, arranged in a manner substantially perpendicular to said second light beam; and wherein
said first transmitted beam results from a first transmission through the substrate of said second light beam, a reflection by the reference mirror and a second transmission through the substrate of the beam reflected by the reference mirror; and
said first and second reflected beams and said first transmitted beam are received by said first wavefront analyzer of the wavefront analysis means.

4. The method as claimed in claim 3, wherein the first light beam and the second light beam are emitted by said first light source.

5. The method as claimed in claim 1, wherein:
said second light beam is incident on said first face of the substrate;
said first transmitted beam results from a first transmission through the substrate of said second light beam; and
said first transmitted beam is received by a second wavefront analyzer of the wavefront analysis means, separate from said first wavefront analyzer.

6. The method as claimed in claim 1, wherein:
said second light beam is emitted by a second light source of the emission means, separate from the first light source, and is incident on said second face of the substrate;
said first transmitted beam results from a first transmission through the substrate of said second light beam; and
said first transmitted beam is received by said first wavefront analyzer of the measurement analysis means.

7. The method as claimed in claim 6, wherein:
said first light beam emitted by said first light source and said second light beam emitted by said second light source have a different wavelength and/or polarization, the method further comprising:
receiving, by a second wavefront analyzer of the wavefront analysis means, separate from said first wavefront analyzer, a second transmitted beam resulting from a first transmission through the substrate of said first incident beam, in order to generate a third measurement signal characteristic of the wavefront of said second transmitted beam; and
comparing said second measurement signal characteristic of the wavefront of said first transmitted beam and said third measurement signal characteristic of the wavefront of said second transmitted beam, in order to generate a signal characteristic of the variations of the refractive index within the substrate.

8. A system for analyzing the surface quality of a substrate with parallel faces, the system comprising:
at least one first support configured to receive the substrate to be analyzed;
emission means comprising at least one first light source for emitting at least one first light beam with low temporal coherence, and having at least one wavelength to which said substrate is at least partially transparent, said emission means being configured so that, in operation, said at least one first light beam is incident on said substrate;
wavefront analysis means comprising at least one first wavefront analyzer and configured, in operation, for:
receiving, on an analysis surface of said first wavefront analyzer, at least one first reflected beam and a second reflected beam, said first reflected beam resulting from the reflection of said at least one first light beam by a first face of the substrate and said second reflected beam resulting from a first transmission through the substrate of said first light beam and then a reflection by a second face of the substrate, followed by a second transmission through the substrate, in order to generate a first measurement signal characteristic of a combination of the wavefronts of said first and second reflected beams;
receiving, by said wavefront analysis means, at least one first transmitted beam resulting from at least one first transmission through the substrate of a second light beam emitted by said emission means, in order to generate a second measurement signal characteristic of the wavefront of said transmitted beam;
a processing unit configured for calculating, from said first measurement signal and said second measurement signal, at least one first signal representative of a deformation of said first face of the substrate relative to a first reference surface and at least one second signal representative of a deformation of the second face of the substrate relative to a second reference surface.

9. The system as claimed in claim 8, wherein said emission means are configured so that, in operation, said at least one first light beam is incident on said substrate in a manner substantially perpendicular to said substrate.

10. The system as claimed in claim 8, wherein said analysis surface of said first wavefront analyzer is substantially optically conjugate with the substrate to be analyzed.

11. The system as claimed in claim 8, further comprising:
a second support configured for receiving a reference mirror, the reference mirror being arranged, in operation, in a manner substantially perpendicular to said second light beam; and wherein, in operation:
said first transmitted beam results from a first transmission of said at least one first incident beam through the substrate, a reflection by the reference mirror and a second transmission through the substrate of the beam reflected by the reference mirror; and
said first and second reflected beams and said first transmitted beam are received by said first wavefront analyzer of the wavefront analysis means.

12. The system as claimed in claim 8, wherein the wavefront analysis means comprise a second wavefront analyzer, separate from the first wavefront analyzer, and:
said emission means are configured so that, in operation, said second light beam is incident on said first face of the substrate, said first transmitted beam resulting from a first transmission through the substrate of said second light beam;
said wavefront analysis means are configured so that, in operation, said first transmitted beam is received by said second wavefront analyzer of the wavefront analysis means.

13. The system as claimed in claim 8, wherein said at least one first wavefront analyzer is chosen from among a Hartmann and Shack-Hartmann wavefront analyzer, a lateral shift interferometer, a moiré deflectometer, and a device based on the Schlieren method.
